(19) United States
(12) Patent Application Publication
(10) Pub. No.: US 2012/0078689 A1
(43) Pub. Date: Mar. 29, 2012

(54) SYSTEMS, DEVICES, AND METHODS OF SUBSIDIZING THE COST OF ELECTRONIC DEVICES BY ALLOWING THE DEVICE MANUFACTURER TO CONTROL DIGITAL ADVERTISING ON THE DEVICE

(75) Inventor: Leigh M. Rothschild, Sunny Isles Beach, FL (US)

(73) Assignee: ARIEL INVENTIONS LLC, Sunny Isles Beach, FL (US)

(21) Appl. No.: 13/272,382

(22) Filed: Oct. 13, 2011

Related U.S. Application Data
(63) Continuation of application No. 13/246,851, filed on Sep. 27, 2011.
(60) Provisional application No. 61/387,086, filed on Sep. 28, 2010.

(51) Int. Cl. G06Q 30/02

(52) U.S. Cl. 705/14.1; 705/14.4; 705/14.69

(57) ABSTRACT

Systems, methods and devices for reducing a price of an electronic device by allowing a device manufacturer to control digital advertising on the electronic device are disclosed. Such systems, methods, and devices may include presenting content on a display, the content having an embedded commercial. Further, embodiments may include detecting the embedded commercial with a screening engine and a screening circuit and providing the screening engine and screening circuit with device advertisement (AD) content by the AD content engine. Additional embodiments may include replacing the embedded commercial with the device AD content by the screening engine and screening circuit. Moreover, selecting the device AD is based on user information by the AD content engine as well as tracking the viewing of the AD content by a tracking module.

### CROSS-REFERENCE TO RELATED APPLICATIONS

The present application claims priority under the laws and rules of the United States, including 35 USC §120, to U.S. patent application Ser. No. 13/246,851, filed on Sep. 27, 2011, which in turn claims priority, under the laws and rules of the United States, including 35 USC §120, to U.S. Provisional Patent Application No. 61/387,086 filed on Sep. 28, 2010. The contents of U.S. patent application Ser. No. 13/246,851 and U.S. Provisional Patent Application No. 61/387,086 are herein incorporated by reference.

### BACKGROUND

Electronics retailing is a billion dollar worldwide business. Very popular consumer items include video monitors including LCD and plasma monitors (e.g. screens, displays, etc.). Computers, both laptop and desktop, which can couple to the monitors, are also a hugely popular consumer item that collectively account for billions of dollars of revenue each calendar year in various industries.

Many manufacturers compete to sell many different consumer electronics such as monitors and computers. These manufacturers include but are not limited to Sony, Apple, Samsung, Panasonic, Dell, Gateway, IBM, Hewlett Packard, Vizio, and LG among others. Competition is intense in retailing these items and many times price plays a crucial factor in a user's/consumer's purchase decision of the item. Any price concessions that can be offered to the end user may be significant to the manufacturer of the item.

Moreover, advertising is also a billion dollar worldwide business. Current advertising functions in a wide variety of mediums from billboards, to Internet advertising (banners, hyperlinks, rollovers, etc.), to television and radio advertising, and also many other forms of advertising. In all cases the objective of the advertiser is to reach a selected audience and then familiarize that audience with a product or service, with the ultimate goal of encouraging the user to purchase the product and service.

Advertisers are currently paying billions of dollars per year to place advertising spots on television and radio as well as Internet websites and other Internet media. These advertising spots (audio and video) may be viewed or listened to on radio and television/monitor/computer devices. The current model is for the advertiser to compensate the broadcast channel or Internet media provider (e.g. radio station, television station, or cable company, website, social media site, etc.) for displaying these advertising spots. The current model does not allow for a device manufacturer to be compensated for advertising that is being broadcast from, watched, or listened to on/via/through the manufacturer's device. Such a scenario may be for a user to purchase a Samsung television LCD display from a selected retailer, for example, Best Buy. The user may then install the display in his/her home. Further, the user may then view digital content on the display which in most cases contains selected advertising spots/commercials. These spots/commercials may vary in length and may normally be interspersed into the digital content that the user is viewing. The current economic model for these advertising spots/commercials is for the provider of the commercials to pay the broadcaster for placing the spots. By example, if the user views an advertising commercial for Heinz ketchup while watching a Hawaii 5-0 television program, the advertiser may pay the television network (e.g. CBS) that is broadcasting the program. In some cases, the advertiser may also pay the cable or satellite service that is transmitting the content into the user's home. There is no such case or scenario that has the advertiser pay the manufacturer of the device (in this example Samsung) or the retailer of the device (in this example Best Buy) on which the user is viewing/listening to the advertising content (e.g. spot, commercial, etc.).

Embodiments of the disclosure include a system and method for a device manufacturer or retailer of the device to receive money/payment from the advertiser for allowing and transmitting content to the user's device. Such revenue may then be used by the manufacturer of the device to offer price reductions to the end user/consumer of the device.

Thus, an objective of the embodiments of the present disclosure may allow a manufacturer to be able to offer the user an electronic device at a reduced cost from the normal retail price point, because the manufacturer or retailer is receiving supplemental income to support a price reduction.

### BRIEF SUMMARY

Embodiments of the present disclosure may include a manufacturer of an electronic device (MU) providing a reduced purchase price on device (when compared to a market price for the device) to a consumer using revenue received from advertisers. Such embodiments may include a consumer purchasing an electronic device that is capable of being connected to the Internet. Such a device can be an audio receiver (radio/amplifier), video receiver (television monitor/screen/display including cathode ray monitors, Plasma monitors, LCD or LED monitors, or any other kind of monitor now existing or known in the future), computer processing device (including laptop or desktop computer or mobile computing device), media player (e.g. DVD player, Blu-Ray disc player) or a DVR device such as a Tivo or Replay digital video recorder.

The consumer's/user's electronic device may contain a memory storage module (MS). This MS can be in the form of read only memory (ROM), or read addressable memory or random-access memory (RAM). The memory storage can be on flash memory circuits or on memory storage units such as a hard disk drive or may utilize optical memory such as a writeable DVD or CD. The MS may also be in the form of an external hard drive including USB thumb/flash drives. The MS may receive and store any digital content that is being directed to the monitor. Further, the MS may be programmed, either by the manufacturer of the device or by the user, to store X seconds of all digital content directed to the monitor/display. This storage of the digital content shall represent buffered digital content in the memory storage and in the an embodiment of this present disclosure may represent at least 180 seconds (three minutes) of digital content.

The user's electronic device may optionally have a display module (DM) integrated to the device or externally coupled to the device. This module may display the digital content that the user wishes to view. Examples of current display modules include Liquid Crystal Displays (LCD), Light Emitting Diode Displays (LEDs), Plasma Displays, and Cathode Ray Displays. The display may also have a speaker or speaker system interconnected or integral to the display to allow the audio content to be heard.

The electronic device shall contain a Video and Audio player module (VP) that may be able to play the digital content including both audio and video content. Examples of such players that currently exist include the Microsoft Media Player, GOM player, VCL Player, Real Player, and Quicktime Player among others. The VP shall play the digital content from the MS and send it to the DM.

The electronic device may also contain a screening and eliminator circuit (SC) located on a microprocessor device that runs preprogrammed computer software to identify all commercial/advertising spots in the digital content. Such systems of identifying and eliminating commercial/advertising spots is currently known in the art and described in U.S. Pat. Nos. 6,983,481, 7,240,354 and 7,454,772 currently assigned to IBM and in other literature currently available.

Once the SC identifies and eliminates commercial and advertising spots, the electronic device may then replace this digital content in the exact length (by example 23 seconds) with another commercial/advertising spot (AD) that may be stored in the MS of the device. In another embodiment of this present disclosure the new digital content (AD) may be streamed into the device from a remote server location. The communication between the device and the remote server may be by cellular, broadcast, cable, satellite, internet connection (WiFi, Ethernet connection, etc) or any other form of communication now known or known in the future. Note, persons of ordinary skill in the art would understand that some AD content may also be referred to as RAS content (advertising/commercial spots).

The AD content may be supplied by the MU or an agent or agents of the MU. The MU may receive revenue compensation from the supplier of the digital content (Advertising/commercial spots) for allowing the AD to be displayed on the electronic device of the User. In another embodiment of present disclosure the MU may also allow the retailer or agents of the retailer to control and supply the AD thus allowing the retailer additional revenue to be used in allowing price concessions to the purchaser of the electronic device.

In a preferred embodiment the AD may be selected for the user of the electronic device based on demographic and psychographic information that the MU has received on the user of the electronic device. This user information may be collected by the MU or by the retailer of the electronic device in the user registration of the electronic device. In still another embodiment, the electronic device may contain a tracking module (TM) that may report back to the MU or agents of the MU that the user has viewed/heard the AD. The TM information may include information on who viewed AD (if this info is available), time of day, exact nature of the digital content that the user was viewing, and any other pertinent information. The recipients of this TM information may compensate either the MU, agents of the MU, or the retailer who sold the electronic device to the user.

Such transmission from the electronic device to a remote server of the MU may be done through cellular, broadcast, cable, satellite, internet connection (WiFi, Ethernet connection, etc.) or any other form of communication now known or known in the future.

By using the revenue received from the advertisers supplying the AD either the MU or the retailer of the electronic device may offer a price concession to the user of the electronic device. This concession may be at the point of purchase of the electronic device, or may be given as a post sale rebate to the purchaser of the electronic device. In another embodiment the price concession may be given to the user depending on the amount of AD content that the user views/hears as reported by the TM to the MU or the retailer of the electronic device.

Embodiments of the disclosure include an exemplary method for reducing a price of an electronic device by allowing a device manufacturer to control digital advertising on the electronic device. Steps of the example method may include presenting content on a display, the content having an embedded commercial. Further steps may include detecting the embedded commercial with a screening engine and a screening circuit and providing the screening engine and screening circuit with device advertisement (AD) content by the AD content engine. Additional steps in the example may include replacing the embedded commercial with the device AD content by the screening engine and screening circuit. Moreover, selecting the device AD is based on user information by the AD content engine as well as tracking the viewing of the AD content by a tracking module.

Persons of ordinary skill in the art would understand that an embedded commercial or advertisement (all of which may be described as AD content) any AD content that is placed in a commercial break while viewing a television program or web/Internet program. Further, an embedded commercial may also be product placement or advertisements embedded within a television program or web/Internet content. For example, a television character may be drinking a brand of soft drink as shown by the packaging of the soft drink. Thus, by known methods in the art, aspects of the present disclosure may detect and then replace the image of a packaging of the soft drink to show another brand of soft drink. Additional examples of embedded commercials may be banner or other ads on webpages as well as pop-ads on mobile device (e.g. mobile phone, tablet computers, etc.) applications. Aspects of the present disclosure, using methods known to a person of ordinary skill in the art, may detect and replace such embedded commercials (e.g. banner/web page ads, pop-up ads, etc.).

Other steps in the example method include the device manufacturer receiving revenue based on the providing of the device AD content by the AD content engine and replacing of the embedded commercial with the device AD content by the screening engine and the screening circuit. A further step may be a device manufacturer receives Ad revenue based on the providing of the device Ad content by the AD content engine and replacing of the embedded commercial with the device AD content by the screening engine and the screening circuit. An additional step in the example method may be reducing a price of an electronic device based on receiving AD revenue generated by replacing of the embedded commercial with the device AD content by the screening engine and the screening circuit. Moreover, the example method may include providing a discount based on replacing of the embedded commercial with the device AD content by the screening engine and the screening circuit. Also, the user information is selected from the group consisting of user demographic information, user psychographic information, user device registration information, user personal information, and user web browsing data.

Embodiments of the disclosure include an exemplary system for reducing a price of an electronic device by allowing a device manufacturer to control digital advertising on the electronic device. The exemplary system may include one or more processors, one or more storage devices coupled to the one or more processors, and one or more communication interfaces coupled to the one or more processors. Further, the system may include a content player that provides content with an embedded commercial as well as a display module that presents the content with the embedded commercial. In addition, the system may include a screening circuit and a screening engine implemented by the one or more processors, the screening circuit and the screening engine detecting the embedded commercial with the content. Also, the system may have an AD content engine that provides device AD content to the screening engine wherein the screening engine and the screening circuit replaces the embedded commercial with the device AD content. The AD content engine may select the device AD based on the user information. The exemplary system may also include a tracking module that tracks the viewing of the device AD content.

The exemplary system allows a device manufacturer to receive AD revenue based on replacing of the embedded commercial with the device AD content by the screening engine and the screening circuit such that the device manufacturer may reduce a price of an electronic device based on receiving AD revenue generated by replacing of the embedded commercial with the device AD content by the screening engine and the screening circuit. Further, a device manufacturer may provide a discount based on replacing of the embedded commercial with the device AD content by the screening engine and the screening circuit. Note, the user information is selected from the group consisting of user demographic information, user psychographic information, user device registration information, use personal information, and user web browsing data.

Embodiments of the disclosure may include an exemplary apparatus for reducing a price of an electronic device by allowing a device manufacturer to control digital advertising on the electronic device. The exemplary apparatus may include one or more processors, one or more storage devices coupled to the one or more processors, and one or more communication interfaces coupled to the one or more processors. Further, the exemplary apparatus may include a screening circuit and a screening engine implemented by the one or more processors, the screening circuit and the screening engine receive content and detect an embedded commercial within the content. In addition, the exemplary apparatus may have an AD content engine that provides device AD content to the screening engine wherein the screening engine and the screening circuit replaces the embedded commercial with the device AD content. The AD content engine selects the device AD based on the user information. In alternative embodiments, the exemplary apparatus may include a remote computer server having the AD content engine. Moreover, the exemplary apparatus may include a tracking module that tracks the viewing of the device AD content.

The exemplary apparatus may allow a device manufacturer to receive AD revenue based on replacing of the embedded commercial with the device AD content by the screening engine and the screening circuit, reduce a price of an electronic device based on receiving AD revenue generated by replacing of the embedded commercial with the device AD content by the screening engine and the screening circuit, and provide a discount based on replacing of the embedded commercial with the device AD content by the screening engine and the screening circuit. Note, the user information is selected from the group consisting of user demographic information, user psychographic information, user device registration information, use personal information, other related information, and user web browsing data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE SEVERAL VIEWS OF THE DRAWINGS

The accompanying drawings, which are incorporated in and constitute part of this specification, illustrate embodiments of the present disclosure and together with the description serve to explain the principles of the present disclosure. The embodiments illustrated herein are presently preferred, it being understood, however, that the present disclosure is not limited to the precise arrangements and instrumentalities shown, wherein:

FIG. 1 shows exemplary system for reducing a price of an electronic device by allowing a device manufacturer to control digital advertising on the electronic device;

FIGS. 2A-2D are exemplary systems used in providing advertising such that the device manufacturer may reduce the price of the electronic device;

FIG. 3 is an exemplary computer server used in an example system for reducing a price of an electronic device by allowing a device manufacturer to control digital advertising on the electronic device;

FIG. 4 is an exemplary flowchart showing an example method for reducing a price of an electronic device by allowing a device manufacturer to control digital advertising on the electronic device.

### DETAILED DESCRIPTION

In the following detailed description, reference is made to the accompanying drawings, which for a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the following description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

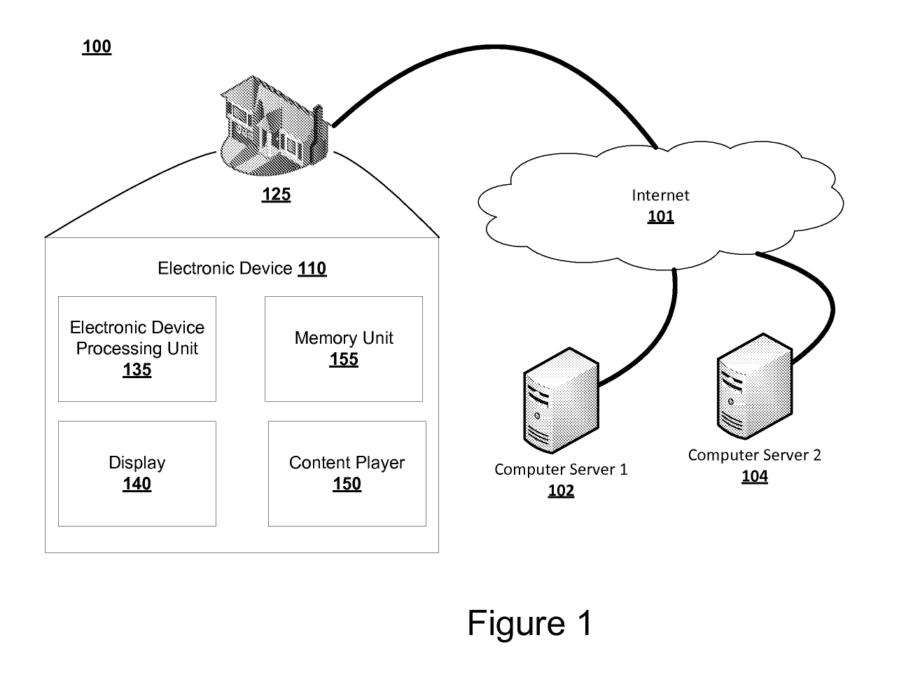

FIG. 1 is an exemplary system 100 for reducing a price of an electronic device by allowing a device manufacturer to control digital advertising on the electronic device. In one embodiment, the electronic device 110 may include a processing unit 135 that implements one or more software application to detect and control advertising (AD) content as well as a memory or storage unit 155 for storing AD content associated with an electronic device manufacturer. Further, the electronic device 110 may include a media content player and a display for a user to view a digital content. Such an electronic device 110 may have the display and the content player as well as the processing unit integrated in one device such as desktop computer, laptop computer, tablet computer, or smartphone. As will be discussed in the present disclosure, other embodiments may be such that the electronic device 110 may include only a subset of the components of the processing unit 135, memory unit 155, display 140, and content player 150.

In one embodiment, the content player 150 may be a streaming video player that streams video content from a remote computer server 102 associated to an Internet video content provider coupled to the electronic device 110 across a communication network 101. The video content is viewed by the user on the display 140. Embedded within the video content may be one or more commercials. The processing unit 135 may have software and/or hardware components to detect the embedded commercials and replace the embedded commercials with AD content associated with device manufacturer stored in the memory unit 155.

In another embodiment, the AD content associated with the electronic device 110 may not be stored in the memory unit 155 of the electronic device but may alternatively be stored on a remote computer server 104 across a communication network 101 such as the Internet. The remote server 104 may be controlled by the manufacturer of the electronic device 110 or may be controlled by the provider of the AD content.

In alternate embodiments, the display 140 and/or content player may not be integrated into one electronic device 110. For example, a computer or some other computing device may be coupled to an LCD television and a satellite provider set-top box. In such an embodiment the LCD television may be the display 140 and the set-top box may be the content player 150. The computing device may include the electronic device processing unit 135 and the memory unit 155. The manufacturer of the computing device may have AD content stored in the memory unit 155 and the processing unit 155 may have hardware and/or software to detect commercials embedded in the content provided by the set-top box and replaces the commercials with AD content stored in the memory unit associated with the device manufacturer.

Other embodiments may have the electronic device include a processing unit 135, memory unit 155, and the content player 150. Such an electronic device may be a set-top box given to the customer by a satellite or cable provider. The set-top box may be coupled to an LCD television that functions as the display 140. Thus, the set-top box manufacturer may have AD content stored in the memory unit 155. Further, the processing unit 135 may have hardware and software that detects the commercials embedded in the content provided by the set-top box and may replace them with AD content stored in the memory unit 155.

In another embodiment, the electronic device may include a processing unit 135, memory unit 155, and the display 140. Such an electronic device may be an LCD television. Further, the LCD television may be coupled to a set-top box provided by a satellite or cable provider, the set-top box may be the content player 140. Thus, LCD television manufacturer may have AD content stored in the memory unit 155. Further, the processing unit 135 may have hardware and software that detects the commercials embedded in the content provided by the set-top box and may replace them with AD content stored in the memory unit 155.

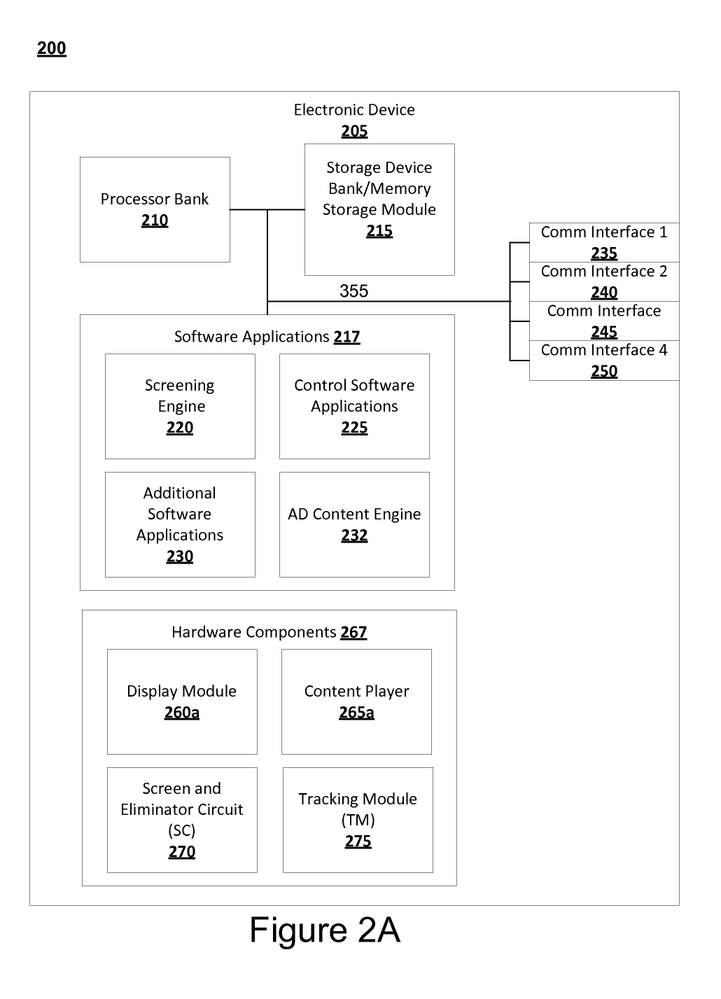

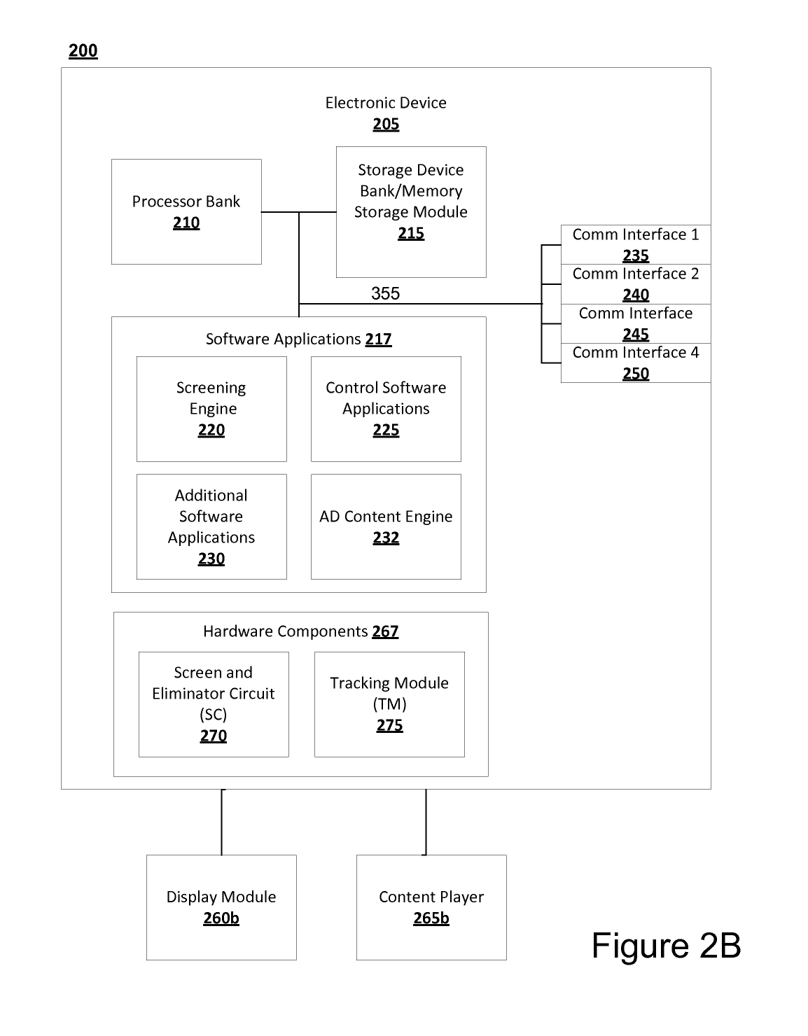

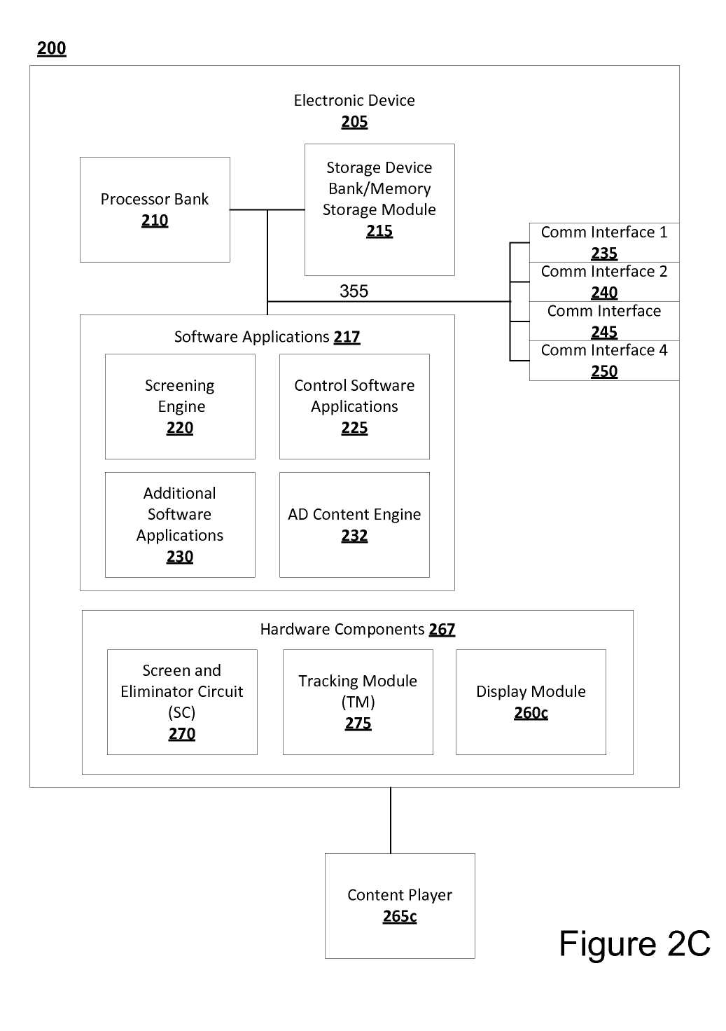

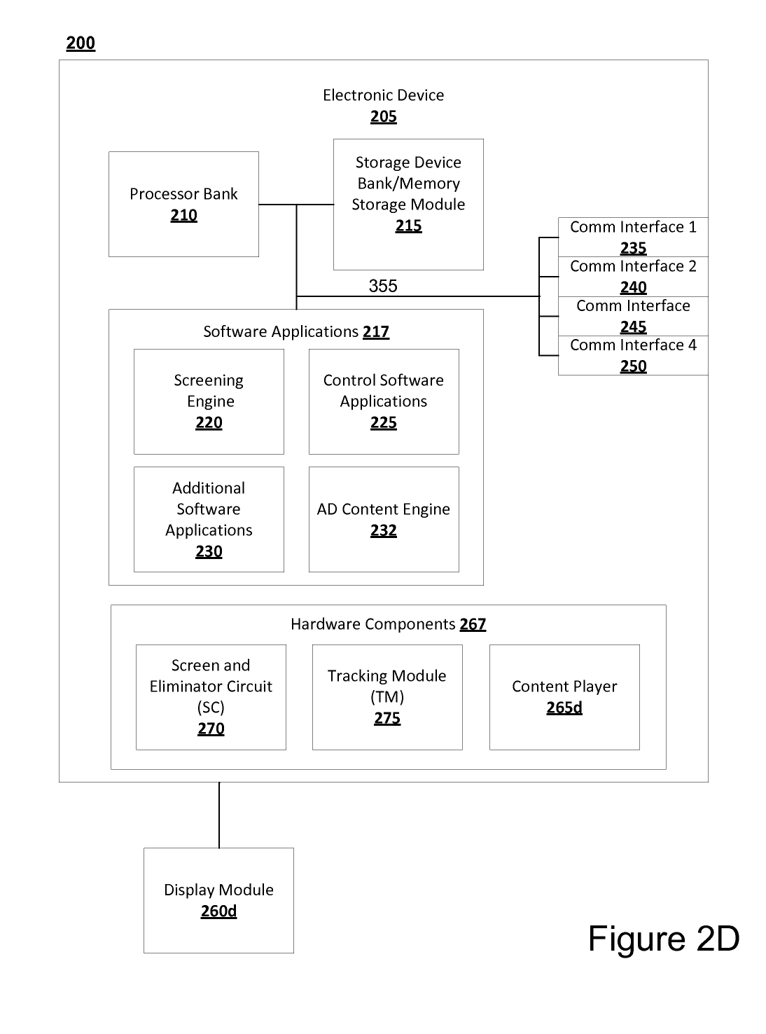

FIGS. 2A-2D are exemplary systems used in providing advertising such that the device manufacturer may reduce the price of the electronic device. Referring to FIG. 2A, the electronic device 205 may include several different components such as a processor bank 210, storage device bank 215, one or more software applications 217, and one or more communication interfaces (235-250). The processor bank 210 may include one or more processors that may be co-located with each other or may be located in different parts of the electronic device 205. The storage device bank 215 may include one or more storage devices. Types of storage devices may include memory devices, electronic memory, optical memory, and removable or external storage media. The one or more software applications 217 may include a screening software engine 220, an AD content software engine 232, control software applications 225 and additional software applications 230. Further, the electronic device 205 may also include additional hardware components such as a display module 260a, content player 265a, a screen eliminator circuit 270, and a tracking module 275.

The control software applications 225 may implement software functions that assist in performing certain tasks for the electronic device 205 such as providing access to a communication network, executing an operating system, managing software drivers for peripheral components, and processing information. Additional software applications 230 may also include software drivers for peripheral components, user interface computer programs, debugging and troubleshooting software tools. Also, the additional software applications 230 may include an operating system supported by the electronic device 205. Such operating systems are known in the art may also include computer and smartphone operating systems (e.g. Droid, Windows 7, Linux, Windows Mobile, MacOS, etc.).

In one embodiment, the electronic device 205 may be a desktop, laptop, tablet computer or smartphone that has the display module 260a and content player 265a integrated with the other components shown in FIG. 2A of the electronic device 205. Further, the content player 265a may provide content (e.g. streaming video) to the display module 260a to be viewed by a user. The screening software engine 220 may function in conjunction with the screen and eliminator circuit (SC) 270 to detect commercials embedded in content provided by the content player 265a. Further, the screen engine 220 and SC 270 may replace the embedded commercials with AD content provided by AD content software engine 232. The AD content may be associated with the electronic device 205. In addition, the AD content engine 232 may select a specific piece of AD content to replace an embedded commercial based on demographic or personal information of the user or the subject matter of the content. For example, the AD content engine 232 may gather information that the user has been browsing travel websites. Therefore the AD content engine 232 may select AD content associated with a hotel. Another example may be that the subject matter of the content detected by the screening engine 220 is a football game. This subject matter information is relayed to and processed by the AD content engine 232 such that the AD content engine 232 provides a piece of AD content associated with sneakers to replace an embedded commercial.

The tracking module (TM) detects and gathers TM information such as whether the AD content that replaced the embedded commercials was viewed/heard/clicked by the user. Further, the TM information may include information on who viewed the replaced AD content (if this information is available), time of day, exact nature or subject matter of the digital content that the user was viewing, and any other pertinent information. The recipients of this TM information may compensate either the device manufacturer, agents of the device manufacturer, or the retailer who sold the electronic device to the user. Such transmission from the electronic device to a remote server of the MU may be done through cellular, broadcast, cable, satellite, internet connection (WiFi, Ethernet connection, etc.) or any other form of communication now known or known in the future. A price concession for the electronic device 205 may be given to the user depending on the amount of AD content that the user views/hears as reported by the TM to the device manufacturer or the retailer of the electronic device 205.

Each of the communication interfaces (235-250) shown in FIG. 2A may be software or hardware associated in communicating to other devices. The communication interfaces (235-250) may be of different types that include a user interface, USB, Ethernet, WiFi, Firewire, WiMax, wireless, optical, cellular, or any other communication interface coupled to communication network.

An intra-device communication link 255 between the processor bank 210, storage device bank 215, software applications 217, and communication interfaces (235-250) may be one of several types that include a bus or other communication mechanism.

Referring to FIG. 2B, display module 260b and content player 265b are not integrated with the electronic device 205. Instead the display module 260b and content player 265b are coupled to the electronic device 205 in some way through a type of interface known in the art. For example, the electronic device may be a computing device (e.g. receiver), the display module 260b may be an LCD television, and the content player 265b may be a set-top box, all which are coupled by appropriate cables as well as physical and software interfaces. The screening engine 220 and the SC 270 may be able detect and replace commercials embedded in the content provided by the set-top box with AD content offered by the AD content engine 232 as described in the present disclosure. Further, the screening engine 220 and SC 270 may be able to detect the subject matter of the content provided by the set-top box. In addition, the TM may be able to gather information associated with the viewing of the AD content and the subject matter of the content as described in the present disclosure.

Referring to FIG. 2C, content player 265c is not integrated with the electronic device 205 but the display module 260c is integrated in the electronic device 205. The content player 265c is coupled to the electronic device 205 in some way through a type of interface known in the art. For example, the electronic device may be an LCD television that includes the display module 260c and the content player 265c may be a set-top box, both which are coupled by appropriate cables as well as hardware a software communication interfaces. The screening engine 220 and the SC 270 may be able detect and replace commercials embedded in the content provided by the set-top box with AD content provided by the AD content engine 232 as described in the present disclosure. Further, the screening engine 220 and SC 270 may be able to detect the subject matter of the content provided by the set-top box. In addition, the TM may be able to gather information associated with the viewing of the AD content and the subject matter of the content as described in the present disclosure.

Referring to FIG. 2D, display module 260d is not integrated with the electronic device 205 but the content player 265d is included in the electronic device 205. The display module 260d is coupled to the electronic device 205 in some way through a type of interface known in the art. For example, the electronic device may be a set-top box that includes the content player 265d and the display module 260d may be an LCD television, both which are coupled by appropriate cables as well as software and hardware interfaces. The screening engine 220 and the SC 270 may be able detect and replace commercials embedded in the content provided by the set-top box with AD content provided by the AD content engine 232 as described in the present disclosure. Further, the screening engine 220 and SC 270 may be able to detect the subject matter of the content provided by the set-top box. In addition, the TM may be able to gather information associated with the viewing of the AD content and the subject matter of the content as described in the present disclosure.

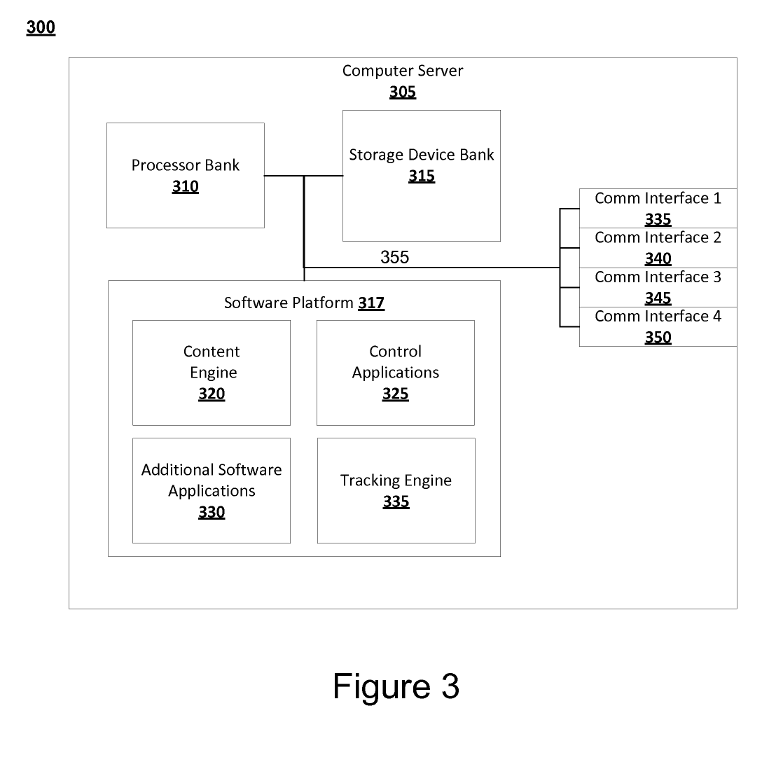

FIG. 3 is an exemplary computer server 305 used in an example system for reducing a price of an electronic device by allowing a device manufacturer to control digital advertising on the electronic device. The computer server 305 may include several different components such as a processor bank 310, storage device bank 315, one or more software applications 317, and one or more communication interfaces (335-250). The processor bank 310 may include one or more processors that may be co-located with each other or may be located in different parts of the computer server 305. The storage device bank 315 may include one or more storage devices. Types of storage devices may include memory devices, electronic memory, optical memory, and removable storage media. The one or more software applications 317 may include a content engine 320, a tracking software engine 335, control software applications 325 and additional software applications 330. The control software applications 325 may implement software functions that assist in performing certain tasks for the computer server 305 such as providing access to a communication network, executing an operating system, managing software drivers for peripheral components, and processing information. Additional software applications 330 may also include software drivers for peripheral components, user interface computer programs, debugging and troubleshooting software tools. Also, the additional software applications 230 may include an operating system supported by the computer server 205. Such operating systems are known in the art may also include computer and smartphone operating systems (e.g. Droid, Windows 7, Linux, Windows Mobile, MacOS, etc.).

In an embodiment an electronic device may detect and replace commercials embedded in content viewed by a user with AD content associated with the electronic device. The AD content may be stored in a remote computer server such as computer server 305 instead of being stored in memory of the electronic device. The content software engine 320 may receive a request for a piece of AD content from the AD content engine of the electronic device as shown in FIGS. 2A-2D. The request may include demographic or personal information of the user or subject matter of the content. Based on such criteria, the content engine 220 may provide the electronic device with AD content to replace a commercial embedded in the content. Further, tracking engine 335 may receive TM information from the tracking module of the electronic device 205 as discussed in the description associated with FIGS. 2A-2D.

Each of the communication interfaces (335-350) shown in FIG. 3 may be software or hardware associated in communicating to other devices. The communication interfaces (335-350) may be of different types that include a user interface, USB, Ethernet, WiFi, WiMax, wireless, optical, cellular, or any other communication interface coupled to communication network.

An intra-device communication link 355 between the processor bank 310, storage device bank 315, software applications 317, and communication interfaces (335-350) may be one of several types that include a bus or other communication mechanism.

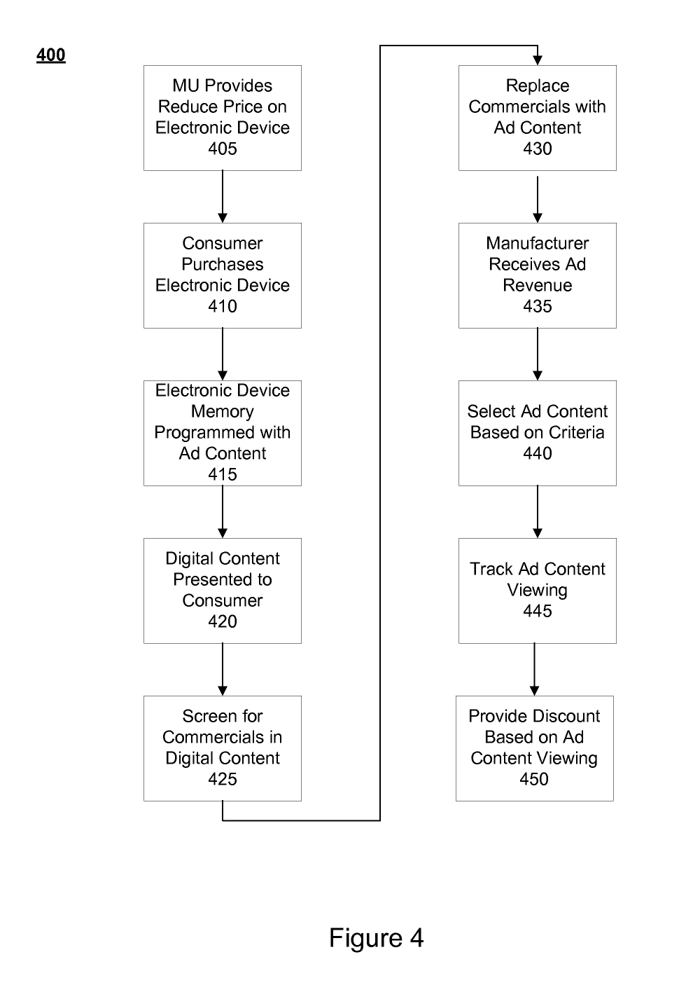

FIG. 4 is an exemplary flowchart 400 showing an example method for reducing a price of an electronic device by allowing a device manufacturer to control digital advertising on the electronic device. A step in the example method may include a manufacturer of an electronic device (MU) to provide a reduced price on the electronic device to a consumer using revenue received from advertisers, as shown in block 405. A further step in the example method may include a consumer purchasing the electronic device which is capable of being connected to the Internet, as shown in block 410. The electronic device can be an audio receiver (radio), video receiver (television monitor including cathode ray monitors, Plasma monitors, LCD or LED monitors, or any other kind of monitor now existing or known in the future), computer processing device (including laptop or desktop computer), or a DVR device such as a Tivo or Replay digital video recorder.

The user's electronic device contains a memory storage module (MS) and may be programmed with AD content, as shown in block 415. This MS can be in the form of read only memory (ROM), read addressable memory, or Random Access Memory (RAM). The memory storage can be on flash memory circuits or on memory storage units such as a hard disk drive or may utilize optical memory such as a writeable DVD or CD. The MS may also be in the form of an external hard drive including USB thumb drives. The MS may receive and store any digital content that is being directed to the monitor. Further, the MS circuit may be programmed, either by the manufacturer of the device or by the user, to store X seconds of all digital content directed to the monitor. This storage of the digital content shall represent a buffer of the digital content in the memory storage and in an embodiment will represent at least 180 seconds (three minutes) of digital content.

The user's electronic device, may optionally as integral to the device, or external to the device contain a display module (DM). Further, the display module may present the digital content that the content wishes to view, as shown in block 420. Examples of current display modules include Liquid Crystal Displays (LCD), Light Emitting Diode Displays (LEDs), Plasma Displays, and Cathode Ray Displays. The display may also have a speaker or speaker system interconnected or integral to the display to allow the audio content to be heard. The electronic device shall contain a Video/Audio player module (VP) that may be able to play the digital content including both audio and video content. Examples of such players that currently exist include the Microsoft Media Player, GOM player, VCL Player, Real Player, and Quicktime Player among others. The VP may play the digital content from the MS and send it to the DM.

The electronic device may also contain a screening and eliminator circuit (SC) located on a microprocessor device that runs preprogrammed computer software to identify all commercial/advertising spots in the digital content, as shown in block 425. Such systems of identifying and eliminating commercial/advertising spots is currently known in the art and described in U.S. Pat. Nos. 6,983,481, 7,240,354 and 7,454,772 currently assigned to IBM and in other literature currently available.

Once the SC identifies and eliminates commercial and advertising spots, the electronic device may then replace this digital content in the exact length (by example 23 seconds) with another commercial/advertising spot (AD) that may be stored in the MS of the device, as shown in block 430. In another embodiment, the new digital content (AD) may be streamed into the device from a remote computer server. The communication between the device and the remote server may be by cellular, broadcast, cable, satellite, internet connection (WiFi, Ethernet connection, etc) or any other form of communication now known or known in the future.

The AD content may be supplied by the MU or an agent or agents of the MU. The MU may receive revenue compensation from the supplier of the digital content (Advertising/commercial spots) for allowing the AD to be displayed on the electronic device of the user/consumer, as shown in bock 435. In another embodiment, the MU may also allow the retailer or agents of the retailer to control and supply the AD thus allowing the retailer additional revenue to be used in allowing price concessions to the purchaser of the electronic device.

In another embodiment, the AD may be selected for the user of the electronic device based on demographic and psychographic information or other criteria that the MU has received on the user of the electronic device, as shown in block 440. This user information may be collected by the MU or by the retailer of the electronic device in the user registration of the electronic device. In still another embodiment, the electronic device may contain a tracking module (TM) that may report tracking information back to a remote server controlled by the MU or agents of the MU that the user has viewed/heard the AD, as shown in block 445. The tracking information may include information on who viewed the AD (if this information is available), time of day, exact nature of the digital content that the user was viewing, and any other pertinent information. The recipients of this TM information may compensated through discounts either the MU, agents of the MU, or the retailer who sold the electronic device to the user, as shown in block 450. Such transmission from the electronic device to a remote server of the MU may be done through cellular, broadcast, cable, satellite, internet connection (WiFi, Ethernet connection, etc) or any other form of communication now know or known in the future. By using the revenue received from the advertisers supplying the AD either the MU or the retailer of the electronic device may offer a price concession to the user of the electronic device. This concession may be at the point of purchase of the electronic device, or may be given as a post sale rebate to the purchaser of the electronic device. In another embodiment of this present disclosure the price concession may be given to the user depending on the amount of AD content that the user views/hears as reported by the TM to the MU or the retailer of the electronic device.

Persons of ordinary skill in the art would understand that an embedded commercial may include video or audio advertisements as well as a banner ad or other graphic/textual advertisement that are displayed on a website ad associated with a hyperlink. Content may be video, audio, or websites that can be viewed though a web browser program.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for reducing a price of an electronic device by allowing a device manufacturer to control digital advertising on the electronic device, the method further comprising:
presenting content on a display, the content having an embedded commercial;
detecting the embedded commercial with a screening engine and a screening circuit;
providing the screening engine and screening circuit with device advertisement (AD) content by the AD content engine;
replacing the embedded commercial with the device AD content by the screening engine and screening circuit.

2. The method of claim 1, further comprising selecting the device advertising (AD) based on user information by the AD content engine.

3. The method of claim 1, further comprising tracking the viewing of the AD content by a tracking module.

4. The method of claim 1, further comprising a device manufacturer receiving AD revenue based on providing the device AD content by the AD content engine and replacing of the embedded commercial with the device AD content by the screening engine and the screening circuit.

5. The method of claim 4, further comprising reducing a price of an electronic device based on receiving AD revenue generated by replacing of the embedded commercial with the device AD content by the screening engine and the screening circuit.

6. The method of claim 1, further providing a discount based on replacing of the embedded commercial with the device AD content by the screening engine and the screening circuit.

7. The method of claim 2, wherein the user information is selected from the group consisting of user demographic information, user psychographic information, user device registration information, user personal information, and user web browsing data.

8. A system for reducing a price of an electronic device by allowing a device manufacturer to control digital advertising on the electronic device, the system further comprising:
one or more processors;
one or more storage devices coupled to the one or more processors;
one or more communication interfaces coupled to the one or more processors'
a content player that provides content with an embedded commercial'
a display module that presents the content with the embedded commercial;
a screening circuit and a screening engine implemented by the one or more processors, the screening circuit and the screening engine detecting the embedded commercial with the content;
an AD content engine that provides device AD content to the screening engine wherein the screening engine and the screening circuit replaces the embedded commercial with the device AD content.

9. The system of claim 8, wherein the AD content engine selects the device AD based on the user information.

10. The system of claim 8, further comprising a tracking module that tracks the viewing of the device AD content.

11. The system of claim 8, wherein a device manufacturer receives AD revenue based on replacing of the embedded commercial with the device AD content by the screening engine and the screening circuit.

12. The system of claim 11, wherein the device manufacturer reduces a price of an electronic device based on receiving AD revenue generated by replacing of the embedded commercial with the device AD content by the screening engine and the screening circuit.

13. The system of claim 8, wherein a device manufacturer provides a discount based on replacing of the embedded commercial with the device AD content by the screening engine and the screening circuit.

14. The system of claim 9, wherein the user information is selected from the group consisting of user demographic information, user psychographic information, user device registration information, use personal information, and user web browsing data.

15. An apparatus for reducing a price of an electronic device by allowing a device manufacturer to control digital advertising on the electronic device, the apparatus further comprising:
one or more processors;
one or more storage devices coupled to the one or more processors;
one or more communication interfaces coupled to the one or more processors'
a screening circuit and a screening engine implemented by the one or more processors, the screening circuit and the screening engine receive content and detect an embedded commercial within the content;
an AD content engine that provides device AD content to the screening engine wherein the screening engine and the screening circuit replaces the embedded commercial with the device AD content.

16. The apparatus of claim 15, wherein the AD content engine selects the device AD based on the user information.

17. The apparatus of claim 15, further comprising a remote computer server having the AD content engine.

18. The apparatus of claim 15, further comprising a tracking module that tracks the viewing of the device AD content.

19. The apparatus of claim 15, wherein a device manufacturer: (i) receives AD revenue based on replacing of the embedded commercial with the device AD content by the screening engine and the screening circuit; (ii) reduces a price of an electronic device based on receiving AD revenue generated by replacing of the embedded commercial with the device AD content by the screening engine and the screening circuit; and (iii) provides a discount based on replacing of the embedded commercial with the device AD content by the screening engine and the screening circuit.

20. The apparatus of claim 16, wherein the user information is selected from the group consisting of user demographic information, user psychographic information, user device registration information, use personal information, and user web browsing data.
